(19) United States
(12) Patent Application Publication
(10) Pub. No.: US 2011/0194276 A1
(43) Pub. Date: Aug. 11, 2011

(54) LED flashing annular ornament

(75) Inventor: Ying-Yee Au, Kowloon (HK)

(73) Assignee: ASIA GLOBAL CORPORATION LTD., Kowloon (HK)

(21) Appl. No.: 12/659,708

(22) Filed: Mar. 18, 2010

(30) Foreign Application Priority Data
Feb. 5, 2010 (TW) 099202422

(51) Int. Cl. A44C 5/00; F21V 21/08

(52) U.S. Cl. 362/104; 63/1.13

(57) ABSTRACT

An LED flashing annular ornament includes a band for putting around a user's wrist or finger; an ornamental cover connected to two facing ends of the band and having a control circuit board and batteries received therein, the control circuit board having a control IC chip and at least one LED provided thereon, and a bottom cap being connected to the ornamental cover to hold the band in place; a power switch arranged on the control circuit board and having an external button; and a vibration switch arranged on the control circuit board. When the external button is pushed to turn on the power switch, power is supplied from the batteries to the control IC chip; and when the user shakes the hand to vibrate the annular ornament while the power switch is on, the vibration switch is turned on and the control IC chip drives the LED to flash.

### FIELD OF THE INVENTION

The present invention relates to an LED flashing annular ornament, and more particularly to an annular ornament having at least one LED that can be caused to flash in a conveniently controllable manner, such as when the annular ornament is vibrated.

### BACKGROUND OF THE INVENTION

Generally, conventional glittering annular ornaments, such as bracelets or rings, are formed by designing different colors, styles, or patterns on outer surfaces of the annular ornaments, so that consumers can purchase the annular ornaments according to their preference. Alternatively, the conventional annular ornaments are provided with one or more light emitting diodes (LEDs) to emit light so as to highlight the beautiful appearance and colors thereof.

The light emitting annular ornaments in the early stages are not provided with a flashing function. It is therefore tried by some manufacturers to develop an LED flashing annular ornament, so that the annular ornament not only emits light but also flashes. The conventional LED flashing annular ornament has a structural control switch being provided on an inner circumferential surface of the annular ornament in contact with a user's hand. The control switch provided on the inner surface of the annular ornament could not be conveniently operated when the annular ornament is worn on the user's hand. Once the control switch is turned on, the LEDs on the annular ornament would keep flashing to continuously consume power and would not automatically stop flashing. The user has to take off the annular ornament to turn off the control switch. The user, particularly a small child, often forgets to turn off the control switch to result in quickly exhausted batteries and unnecessary waste of electric energy. Further, since the conventional LED flashing annular ornament requires frequent replacement of batteries thereof, it would no doubt bring inconveniences to the user.

To overcome the disadvantages of the conventional LED flashing annular ornament, it is tried by the inventor to develop an LED flashing annular ornament, the LEDs of which will emit colorful flashing lights in a conveniently controllable manner, such as when the user shakes hand to vibrate the annular ornament, so that the LED flashing annular ornament can save power consumption thereof while showing a fashionable appearance.

### SUMMARY OF THE INVENTION

A primary object of the present invention is to provide an LED flashing annular ornament, the LEDs of which can emit flashing light of different colors in a conveniently controllable manner, such as when the annular ornament is vibrated, so that the LED flashing annular ornament can save power consumption thereof while showing a fashionable appearance.

To achieve the above and other objects, the LED flashing annular ornament according to a preferred embodiment of the present invention includes a band having two spaced facing ends for putting around a user's wrist or finger; an ornamental cover connected at two opposite ends to the two spaced facing ends of the band and defining an inner space for receiving a control circuit board and batteries therein, the control circuit board having a control IC chip and at least one LED provided thereon, and a bottom cap being connected to an open bottom of the ornamental cover to firmly hold the band between the ornamental cover and the bottom cap; a power switch arranged on the control circuit board and having an external button projected from the bottom cap; and a vibration switch being a vibration sensor arranged on the control circuit board. When the external button is pushed to turn on the power switch, electric power is supplied from the batteries to the control IC chip; and when the user shakes the hand to vibrate the annular ornament while the power switch is on, the vibration switch is turned on and the control IC chip drives the LED to flash.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an LED flashing annular ornament according to a preferred embodiment of the present invention;

FIG. 2 is an assembled view of FIG. 1;

FIG. 3 is a circuit diagram of the LED flashing annular ornament according to the preferred embodiment of the present invention; and

FIG. 4 shows the LED flashing annular ornament according to the preferred embodiment of the present invention in use.

### DETAILED DESCRIPTION OF THE PREFERRED EMBODIMENTS

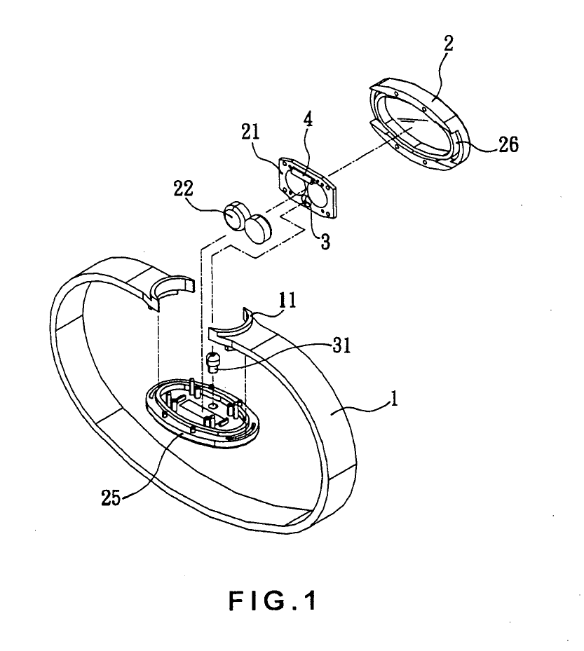

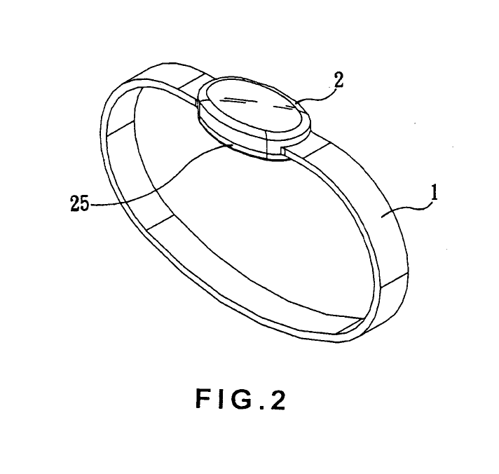

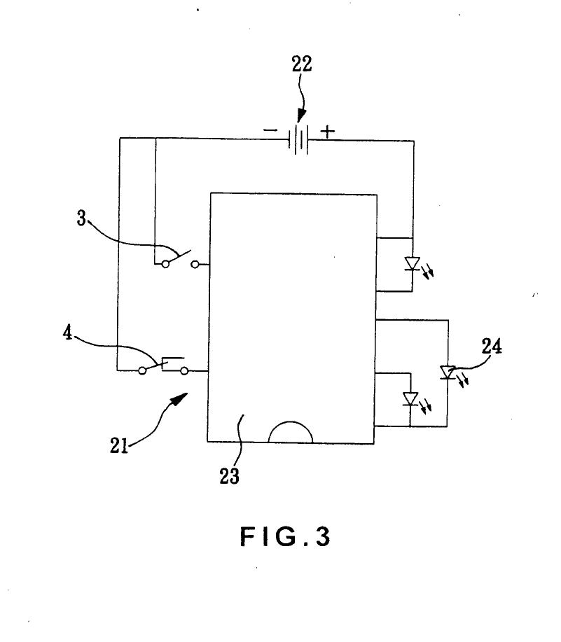

Please refer to FIGS. 1 and 2 that are exploded and assembled perspective views, respectively, of an LED flashing annular ornament according to a preferred embodiment of the present invention, and to FIG. 3 that is a circuit diagram of the LED flashing annular ornament of FIGS. 1 and 2.

As shown, in the preferred embodiment, the LED flashing annular ornament includes a band 1, an ornamental cover 2, a power switch 3, and a vibration switch 4 serving as a flash actuating switch. The band 1 has two facing but spaced ends for putting around a user's wrist or finger. The ornamental cover 2 has a light-transmitting top and defines an inner space for receiving a control circuit board 21 and batteries 22 therein. The control circuit board 21 has a control integrated circuit (IC) chip 23 and at least one LED 24 mounted thereon. The cover 2 is connected at two opposite ends to the two spaced facing ends of the band 1. A bottom cap 25 is connected to an open bottom side of the cover 2, so that the band 1 is firmly associated with the cover 2 and the bottom cap 25. The power switch 3 is arranged on the control circuit board 21 and includes an external button 31 outward projected from the bottom cap 25. The vibration switch 4 is a vibration sensor arranged on the control circuit board 21 and can be triggered to turn on by vibration.

Please refer to FIG. 1. In implementing the present invention, the band 1 can be made of a silicone elastomer. A raised portion 11 is formed on each of the two spaced facing ends of the band 1, and a recess 26 corresponding to the raised portion 11 is formed on each of the two opposite ends of the cover 2, so that the cover 2 is connected to the band 1 through engagement of the recesses 26 with the raised portions 11.

The LED 24 can be changed to show different colors according to the user's preference. In other operable embodiments, the vibration switch 4 can be replaced with other types of flash actuating switches, such as a sound-controlled switch, a motion-activated switch, a touch-controlled switch, or a light sensing switch, so that the LED 24 can be controlled by different manners to flash.

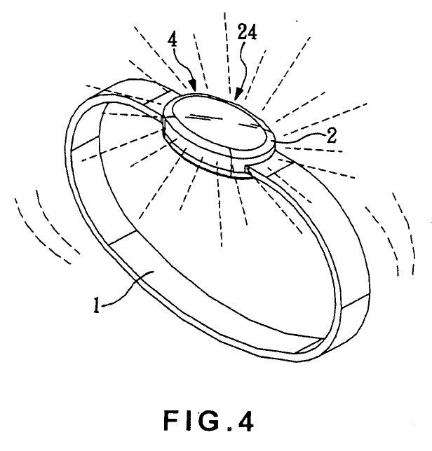

FIG. 4 shows the LED flashing annular ornament according to the preferred embodiment of the present invention in use. Please refer to FIGS. 1 to 4 at the same time. When the external button 31 is pushed to turn on the power switch 3, electric power is supplied from the batteries 22 to the control IC chip 23. And, when the user shakes the hand wearing the annular ornament of the present invention, the vibration switch 4 is vibrated and turned on, bringing the control IC chip 23 to drive the LED 24 to flash. Therefore, the LED flashing annular ornament of the present invention can have reduced power consumption to automatically save electric energy.

More specifically, according to the circuit diagram of the preferred embodiment of the present invention shown in FIG. 3, two DC 3V coin cell batteries 22 together form a 6V power supply, which is supplied to the control IC chip 23 for controlling the LED 24 to flash. The two DC 3V coin cell batteries 22, the power switch 3, and the vibration switch 4 are electrically connected to one another to constitute the circuitry of the present invention.

When the external button 31 of the power switch 3 is pushed, the control IC chip 23 is electrically connected to the main power supply batteries 22, and the LED 24 would flash for one cycle and then stops flashing. Then, when the vibration switch 4 is vibrated while the power switch 3 is on, a control signal from the vibration switch 4 actuates the control IC chip 23 to supply electric power to the LED 24, so that the LED 24 flashes in a predetermined cyclic manner and then stops flashing when the predetermined cycle or cycles are completed. The control IC chip 23 would not output electric current to the LED 24 until the annular ornament is vibrated next time. At and only at this point, the control IC chip 23 supplies electric current to the LED 24 for the latter to flash once again. With these arrangements, the LED flashing annular ornament of the present invention can operate in an energy-saving manner without causing the user any inconvenience of frequent replacement of batteries due to forgetting to turn off the power switch.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An LED flashing annular ornament, comprising:
a band having two spaced facing ends for putting around a user's wrist or finger;
an ornamental cover having a light-transmitting top and defining an inner space for receiving a control circuit board and batteries therein; the control circuit board having a control IC chip and at least one LED provided thereon; the cover being connected at two opposite ends to the two spaced facing ends of the band and at an open bottom side to a bottom cap, such that the band is firmly associated with the cover and the bottom cap;
a power switch being arranged on the control circuit board and including an external button outward projected from the bottom cap; and
a flash actuating switch being arranged on the control circuit board;
whereby when the external button of the power switch is pushed, electric power is supplied from the batteries to the control IC chip; and when the flash actuating switch is triggered and turned on while the power switch is on, the control IC chip is controlled to drive the LED to flash.

2. The LED flashing annular ornament as claimed in claim 1, wherein the ornamental cover is provided at the two opposite ends with a recess each, and the band is made of a silicone elastomer and has a raised portion formed on each of the two spaced facing ends corresponding to the recesses, so that the cover is connected to the band through engagement of the recesses with the raised portions.

3. The LED flashing annular ornament as claimed in claim 1, wherein the batteries received in the ornamental cover include two DC 3V coil cell batteries for supplying a low-voltage DC 6V voltage source.

4. The LED flashing annular ornament as claimed in claim 1, wherein the control IC chip supplies electric power to the at least one LED.

5. The LED flashing annular ornament as claimed in claim 4, wherein the at least one LED is changeable to show different colors.

6. The LED flashing annular ornament as claimed in claim 1, wherein the flash actuating switch is selected from the group consisting of a vibration switch, a sound-controlled switch, a motion-activated switch, a touch-controlled switch, and a light sensing switch; and a signal from any of these switches in an on state controls the control IC chip to drive the at least one LED to flash.
